(19) United States
(12) Patent Application Publication
(10) Pub. No.: US 2024/0037592 A1
(43) Pub. Date: Feb. 1, 2024

(54) INFORMATION PROCESSING DEVICE, GUIDING SYSTEM, GUIDING METHOD, AND COMPUTER READABLE MEDIUM

(71) Applicant: NEC Corporation, Minato-ku, Tokyo (JP)

(72) Inventors: Masahiro Tani, Tokyo (JP); Kazufumi Kojima, Tokyo (JP); Keisuke Ikeda, Tokyo (JP)

(73) Assignee: NEC Corporation, Minato-ku, Tokyo (JP)

(21) Appl. No.: 18/022,039

(22) PCT Filed: Sep. 29, 2020
(86) PCT No.: PCT/JP2020/036769

§ 371 Date: Feb. 17, 2023

(51) Int. Cl. G06Q 30/0207; G07C 1/10; G06Q 50/30

(52) U.S. Cl. CPC G06Q 30/0212; G07C 1/10; G06Q 50/30

(57) ABSTRACT

An imparting unit determines whether to issue a coupon or calculates a point on the basis of a staying time in the limited area, the coupon and the point being exchangeable with an article provided in the limited area by a user who is a soon-to-be passenger to board a plane. The limited area indicates an area in which a soon-to-be passenger stays until he or she boards a plane after a security check. In addition, the staying time in the limited area indicates an elapsed time from entry to the limited area to a predetermined imparted timing. An output unit outputs, on a mobile terminal of the user, information notifying of an issuance of a coupon when the imparting unit determines to issue the coupon, or information about the point calculated by the imparting unit.

### TECHNICAL FIELD

The present invention relates to a technique for guiding a soon-to-be passenger boarding a plane from a general area (public area) to a limited section (limited area) at an airport.

### BACKGROUND ART

An airport has an area called a general area or a public area (hereinafter, referred to as a public area) and an area called a limited section or a limited area (hereinafter, referred to as a limited area). The limited area is an area where a soon-to-be passenger boarding a plane stays until the person boards the plane after the security check. The security check is an inspection for performing a body check of a soon-to-be passenger and a check of baggage brought into the plane. Since the limited area is an area where the soon-to-be passenger who has performed the security check stays, the limited area is an area where there is little concern about the occurrence of terrorism.

On the other hand, the public area is an area where not only a soon-to-be passenger of a plane but also a sending-off person, a user of a commercial facility of an airport, and the like can enter, and is an area where various people who have not performed security check gather. For this reason, there is a concern about the occurrence of terrorism in public areas.

In order to reduce the risk of terrorism occurrence in public areas, it is conceivable to alleviate the congestion situation in public areas.

PTL 1 (JP 2011-141773 A) discloses an automatic ticketing system devised to alleviate a congestion rate of a train. That is, in the automatic ticketing system in PTL 1, when the time during which a passenger carrying an IC card with a commutation ticket passes through the ticketing apparatus is a use time zone designated by the passenger himself/herself and a time zone in which a congestion rate of a train is low, a certain point is granted to the IC card. Such an automatic ticketing system can guide passengers to a time zone with a low congestion rate by imparting more points to pass through the ticketing apparatus in a time zone with a low congestion rate than in a time zone with a high congestion rate. That is, the automatic ticketing system disclosed in PTL 1 guides passengers in a time zone with a low congestion rate, so that the number of passengers can be reduced in a time zone with a high congestion rate, and the congestion of the train can be alleviated.

### CITATION LIST

### Patent Literature

[PTL 1] JP 2011-141773 A

### SUMMARY OF INVENTION

### Technical Problem

There have been proposed various systems for guiding a soon-to-be passenger boarding a plane to a boarding gate so as not to miss the plane scheduled to board. However, since such a system is merely a system that guides passengers to the boarding gate based on the boarding time of the plane, it is not considered that such a system greatly contributes to the mitigation of the congestion situation in the public area.

The present invention has been devised in order to solve the above problems. That is, a main object of the present invention is to provide a technique capable of alleviating a congestion situation in a public area at an airport.

### Solution to Problem

In order to achieve the above object, as one aspect, an information processing device according to the present invention includes:
an imparting means configured to determine whether to issue a coupon exchangeable for an article provided in a limited area or calculate a number of points exchangeable for an article provided in the limited area, based on a staying time that is an elapsed time from entrance to the limited area, which is an area where a user who is a soon-to-be passenger to board a plane stays until boarding the plane after security check, to a predetermined imparting timing; and
an output means configured to output, to a mobile terminal of the user, information for notifying that the coupon is to be issued when it is determined that the coupon is to be issued or information on the calculated number of points.

As one aspect, the guiding system of the present invention includes:
the information processing device; and
a mobile terminal including a display device that displays information output by the output means of the information processing device, or a display device that displays information output by the output means of the information processing device; and a time calculation means that calculates a staying time from an entrance time acquired by reception of information indicating that the user has entered the limited area to the imparting timing.

As one aspect, the guiding method of the present invention includes:
determining whether to issue a coupon exchangeable for an article provided in a limited area or calculating a number of points exchangeable for an article provided in the limited area, based on a staying time that is an elapsed time from entrance to the limited area, which is an area where a user who is a soon-to-be passenger to board a plane stays until boarding the plane after security check, to a predetermined imparting timing; and
outputting, to a mobile terminal of the user, information for notifying that the coupon is to be issued when it is determined that the coupon is to be issued or information on the calculated number of points.

As one aspect, a program storage medium of the present invention storing a computer program for causing a computer to execute:
determining whether to issue a coupon exchangeable for an article provided in a limited area or calculating a number of points exchangeable for an article provided in the limited area, based on a staying time that is an elapsed time from entrance to the limited area, which is an area where a user who is a soon-to-be passenger to board a plane stays until boarding the plane after security check, to a predetermined imparting timing; and
outputting, to a mobile terminal of the user, information for notifying that the coupon is to be issued when it is determined that the coupon is to be issued or information on the calculated number of points.

### Advantageous Effects of Invention

According to the present invention, it is possible to alleviate a congestion situation in a public area at an airport.

### BRIEF DESCRIPTION OF DRAWINGS

FIG. 1 is an image diagram schematically illustrating an application example of a guiding system according to the present invention.

FIG. 2 is a diagram for explaining an area where a soon-to-be passenger can enter at an airport.

FIG. 3 is a block diagram for explaining a configuration of a guiding system of a first example embodiment according to the present invention.

FIG. 4 is a graph illustrating an example of a relationship between a winning probability and a staying time.

FIG. 5 is a flowchart illustrating an example of an operation of a mobile terminal in the first example embodiment.

FIG. 6 is a flowchart illustrating an example of an operation of a server in the first example embodiment.

FIG. 7 is a block diagram for explaining a configuration of a guiding system of a second example embodiment according to the present invention.

FIG. 8 is a flowchart illustrating an example of an operation of a server in the second example embodiment.

FIG. 9 is a block diagram for explaining an example of a function of a guiding system according to a third example embodiment of the present invention.

FIG. 10 is a graph illustrating an example of a relationship between an additional probability and a reference time.

FIG. 11 is a graph illustrating an example of a relationship between an additional probability and a staying time in a limited area at another airport.

FIG. 12 is a graph illustrating an example of a relationship between the number of imparted points and a staying time.

FIG. 13 is a block diagram schematically illustrating a configuration of an information processing device according to another example embodiment of the present invention.

FIG. 14 is a block diagram schematically illustrating a configuration of a guiding system according to another example embodiment of the present invention.

### EXAMPLE EMBODIMENT

Hereinafter, an example embodiment according to the present invention will be described with reference to the drawings.

### First Example Embodiment

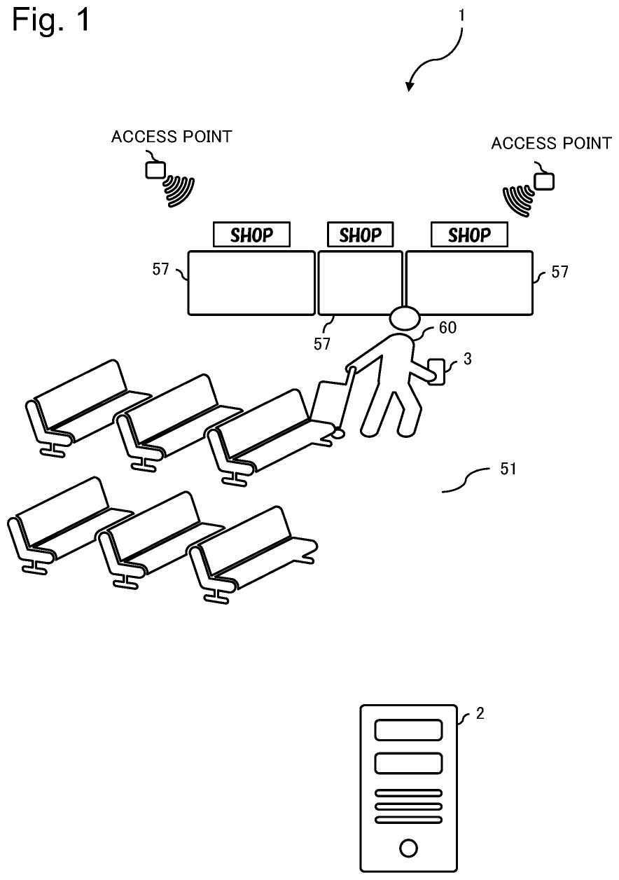

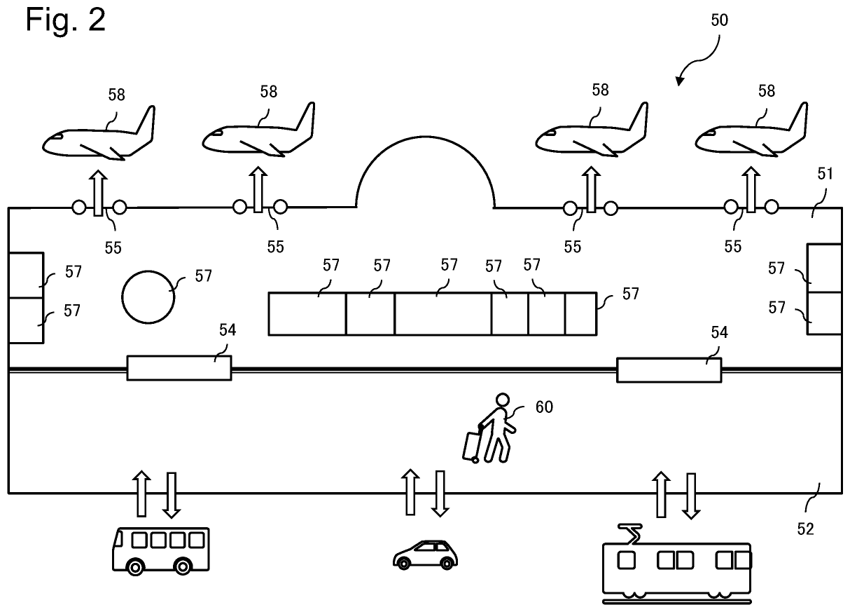

FIG. 1 is a diagram illustrating an image of a guiding system according to a first example embodiment of the present invention. A guiding system 1 is a system that guides a soon-to-be passenger 60 from a public area to a limited area in an airport and reduces a staying time of a soon-to-be passenger 60 in the public area, thereby alleviating a congestion situation in the public area. That is, as illustrated in FIG. 2, the airport 50 includes a limited area 51 and a public area 52 as areas where the soon-to-be passenger 60 can enter. The limited area 51 and the public area 52 are separated by a wall or the like so that a person cannot freely enter and exit, but there is a portion serving as a communication passage that communicates the limited area 51 and the public area 52, and a security check site 54 is provided in this portion. The security check site 54 is a place where a security check is performed to perform a body check of the soon-to-be passenger 60 boarding a plane 58 and a check of baggage brought into the plane. When arriving at the airport 50, the soon-to-be passenger 60 first enters the public area 52. Thereafter, the soon-to-be passenger 60 performs security check at the security check site 54, and can enter the limited area 51 from the public area 52 only when the entry into the limited area 51 is permitted by the security check.

That is, the limited area 51 is an area where the soon-to-be passenger 60 stays until boarding the plane 58 through a boarding gate 55 after the security check. A store 57 is provided in the limited area 51. The store 57 includes a retail store that sells articles such as clothing and miscellaneous goods, a restaurant that provides meals, and the like. On the other hand, the public area 52 is an area where not only the soon-to-be passenger 60 but also a sending-off person, a user of a commercial facility (not illustrated) of the airport 50, and the like can enter, and is an area where various people who have not performed security check gather.

The guiding system 1 of the first example embodiment is a system that executes lottery for determining whether to issue a coupon available at the store 57 in the limited area 51 to a user who is the soon-to-be passenger 60 staying in the limited area 51, and issues a coupon according to a lottery result. In the guiding system 1, in the lottery related to coupon issuance, the probability (in other words, the winning probability of the coupon) that a coupon will be issued increases as the time during which the user stays in the limited area 51 increases. As a result, in the guiding system 1, in order to increase the winning probability of the coupon, the user who is the soon-to-be passenger 60 is caused to take an action of entering the limited area 51 early from the public area 52 in order to lengthen the time staying in the limited area 51.

In order to achieve the system as described above, the guiding system 1 of the first example embodiment includes, as illustrated in FIG. 1, a server 2 that is an information processing device and a mobile terminal 3 possessed by a user who is a soon-to-be passenger 60. The server 2 and the mobile terminal 3 are connected via an information communication network. A plurality of mobile terminals 3 can be connected to the server 2.

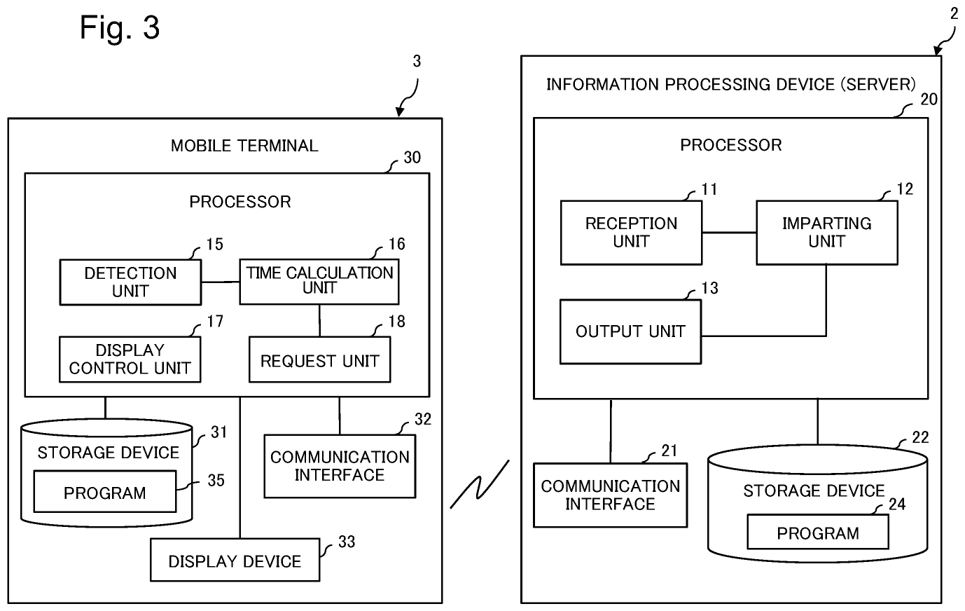

FIG. 3 is a block diagram for explaining configurations of the server 2 and the mobile terminal 3. The server 2 is connected to the mobile terminal 3 by using wireless communication, and the server 2 includes a processor 20, a communication interface 21, and a storage device 22. The communication interface 21 is a device that communicates with another communication device using an information communication network.

The storage device 22 includes a storage medium that stores data and a computer program (hereinafter, also referred to as a program) 24. There are a plurality of types of storage devices such as a magnetic disk device and a semiconductor memory element, and there are a plurality of types of semiconductor memory elements such as a random access memory (RAM) and a read only memory (ROM). The type of the storage device 22 included in the server 2 is not limited to one, and a plurality of types of storage devices 22 are often included in the server 2. Here, the type and number of storage devices 22 provided in the server 2 are not limited, and the description thereof will be omitted. In a case where a plurality of types of storage devices 22 is provided in the server 2, they are collectively referred to as a storage device 22.

As one of the programs 24 stored in the storage device 22, an application program APs for causing the server 2 to have a function as a server constituting the guiding system 1 is stored. The storage device 22 stores, as another program 24, an application program APm for causing the mobile terminal 3 to have a function for using the guiding system 1.

The processor 20 is, for example, a central processing unit (CPU), and can have various functions based on the program 24 by reading and executing the program 24 stored in the storage device 22. The processor 20 of the server 2 included in the guiding system 1 includes a reception unit 11, an imparting unit 12, and an output unit 13 as functional units based on the application program APs.

The reception unit 11 has a function of receiving staying time information together with a lottery request from the mobile terminal 3 via an information communication network. The staying time information is information indicating an elapsed time after the mobile terminal 3 (in other words, the user (the soon-to-be passenger 60) who possesses the mobile terminal 3) enters the limited area 51 of the airport 50. Here, an elapsed time after entering the limited area 51 is also referred to as a staying time in the limited area 51. The staying time information is associated with user identification information that is information for identifying the user. Further, the lottery request is a command to execute a lottery as to whether to issue a coupon.

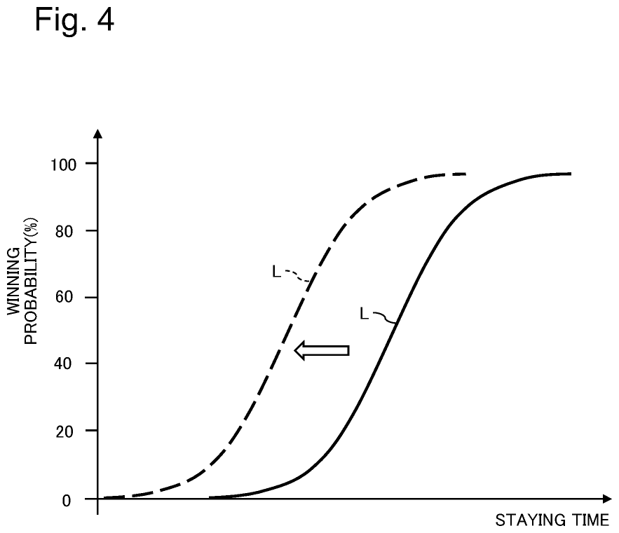

The imparting unit 12 has a lottery function of randomly determining whether to issue a coupon with a winning probability according to the staying time in the limited area 51 when receiving the lottery request via the reception unit 11. The winning probability is a probability that a coupon is issued, and here, the winning probability is determined according to the staying time in the limited area 51 based on the staying time information received by the reception unit 11 from the mobile terminal 3 together with the lottery request. A solid line L in FIG. 4 is a graph illustrating an example of a relationship between the winning probability of the coupon and the staying time in the limited area 51. As indicated by the solid line L in FIG. 4, the winning probability of the coupon increases as the staying time in the limited area 51 increases. Data representing the relationship between the winning probability and the staying time in the limited area 51 is predetermined and stored in the storage device 22 as winning probability data.

The relationship between the winning probability of the coupon as the winning probability data and the staying time in the limited area 51 is not limited to the relationship represented by the sigmoid function as illustrated in FIG. 4, and may be, for example, a relationship represented by a linear function in which the winning probability increases as the staying time increases. Regarding the generation of the winning probability data, a lower limit value (for example, 0%) and an upper limit value (for example, 100%) of the winning probability are set in advance, and the winning probability data is generated such that the winning probability falls within a range of the lower limit value or more and the upper limit value or less.

That is, when receiving the lottery request and the staying time information from the mobile terminal 3 side via the reception unit 11, the imparting unit 12 acquires information of the winning probability related to the staying time in the limited area 51 from the winning probability data in the storage device 22. Then, the imparting unit 12 randomly determines whether to issue a coupon (in other words, whether the coupon has been won or lost) with the acquired winning probability.

Incidentally, information such as content of a coupon available in the limited area 51 and information on the store 57 where the coupon can be used is stored in the storage device 22 as coupon data. The number of types of coupons that can be used in the limited area 51 is not limited to one, and may be two or more. For example, when a plurality of stores 57 are provided in the limited area 51 and the plurality of the stores 57 sponsor the guiding system 1, a coupon according to each of the sponsoring stores 57 may be prepared. One type of coupon may be prepared or a plurality of types of coupons may be prepared for one sponsor store 57, and the content and the number of types of coupons to be prepared are left to the store 57. The coupon data including the content of the coupon prepared by the store 57 and the information (store identification information) of the available store 57 is stored in the storage device 22 as described above.

The imparting unit 12 also has a function of determining the type of coupon to be issued from among a plurality of types of prepared coupons in a case where a plurality of types of coupons are prepared and issuance of a coupon is determined. In determining the type of coupon to be issued, the imparting unit 12 randomly determines one type of coupon to be issued from among all types of coupons available in the limited area 51 (in other words, all types of coupons stored in the storage device 22 as coupon data).

Alternatively, the imparting unit 12 may determine a coupon of the store 57 close to the location of the mobile terminal 3 of the issuing destination to which the coupon is issued as the coupon to be issued. In this case, regarding the store 57 that sponsors the guiding system 1, the position information in the limited area 51 is stored in advance in the storage device 22 in association with the store identification information for identifying the store 57. For example, it is assumed that the location of the store 57 is expressed as, for example, a communication area of an access point PA for a store A and a communication area of an access point PZ for a store B using an access point of a wireless local area network (LAN) in the limited area 51. In this case, the position information of the store 57 is information in which access point identification information for identifying the access point of the wireless LAN is associated with the store identification information. The information of the location of the issuing destination mobile terminal 3 (in other words, the mobile terminal 3 that has output the lottery request) that issues the coupon is acquired from the identification information of the access point in connection to the wireless LAN used by the coupon issuing destination mobile terminal 3.

That is, when a coupon according to the location of the mobile terminal 3 at the coupon issuing destination is issued, the imparting unit 12 acquires identification information of an access point in connection in the mobile terminal 3 as information on the location of the mobile terminal 3 at the coupon issuing destination. Then, using the store identification information associated with the acquired access point identification information, the imparting unit 12 extracts a coupon available in the store 57 close to the location of the mobile terminal 3 of the coupon issuing destination from the coupon data of the storage device 22. In a case where there is one extracted coupon, the imparting unit 12 determines the extracted coupon as a coupon to be issued. When there are a plurality of extracted coupons, the imparting unit 12 randomly determines a coupon to be issued from among the plurality of extracted coupons.

Alternatively, the imparting unit 12 may determine a coupon to be issued from among a plurality of types of coupons by referring to an issuance history of a coupon issued to the user of the mobile terminal 3. In this case, information indicating the type of coupon issued to the user is associated with the user identification information and stored in the storage device 22 as information of an issuance history. The imparting unit 12 refers to the coupon issuance history and determines a coupon to be issued from among the types of coupons other than the issued coupons, for example.

As a further function, the imparting unit 12 has a function of generating (updating) information of an issuance history in which a lottery result (result of winning or losing), information indicating a type of issued coupon in a case of issuing a coupon, and user identification information are associated with each other, and storing the information in the storage device 22.

The output unit 13 has a function of outputting a notification notifying the coupon lottery result by the imparting unit 12 to the mobile terminal 3 at the coupon issuing destination (that is, the mobile terminal 3 that has output the lottery request).

Further, the output unit 13 has a function of transmitting the application program APm read from the storage device 22 to the mobile terminal 3 as a request source when receiving a command to request the application program APm for the system application from the mobile terminal 3.

As illustrated in FIG. 3, the mobile terminal 3 includes a processor 30, a storage device 31, a communication interface 32, and a display device 33. The display device 33 is a device having a configuration for displaying information such as a video and a character, and a display operation thereof is controlled by the processor 30. The communication interface 32 is a device that communicates with another communication device using an information communication network.

The storage device 31 includes a storage medium that stores data and a computer program (program) 35. There are a plurality of types of the storage device 31, and the storage device 31 mounted on the mobile terminal 3 is not limited to one type. In a case where a plurality of types of storage devices 31 are provided in the mobile terminal 3, they are collectively referred to as a storage device 31 here. The application program APm acquired from the server 2 is stored in the storage device 31 as one of the programs 35. User identification information for identifying the user of the mobile terminal 3 is stored in the storage device 31.

The processor 30 is a processor such as a central processing unit (CPU), and can have various functions based on the program 35 by reading and executing the program 35 stored in the storage device 31. Here, the processor 30 includes a detection unit 15, a time calculation unit 16, a display control unit 17, and a request unit 18 as functional units on the basis of the application program APm.

The display control unit 17 has a function of controlling a display operation of the display device 33.

The detection unit 15 has a function of detecting entrance to the limited area 51 by acquiring information indicating that the mobile terminal 3 (in other words, the user who possesses the mobile terminal 3 (the soon-to-be passenger 60)) has entered the limited area 51 of the airport 50. Here, information indicating that the user has entered the limited area 51 is referred to as entrance information. One of the methods by which the mobile terminal 3 acquires the entrance information is a method of using a signal called a beacon transmitted from an access point of a wireless LAN installed in the limited area 51. In this case, the identification information of the access point of the wireless LAN installed in the limited area 51 is acquired in advance from the server 2 and stored in the storage device 31. The detection unit 15 detects identification information of an access point in connection from the received beacon. Then, when the detection unit 15 detects that the identification information of the access point in connection is the access point of the limited area 51 in a state where the detection unit 15 does not detect that the user has entered the limited area 51, the detection unit 15 detects that the user has entered the limited area 51.

Alternatively, in the limited area 51, an entrance detection device may be installed near an entrance entering the security check site 54, and the detection unit 15 may detect entrance into the limited area 51 by a signal output from the entrance detection device. That is, the entrance detection device is a device that outputs a signal (hereinafter, also referred to as an entrance signal) indicating that the user has entered the limited area 51 toward the mobile terminal 3 using a short-range wireless communication technology such as radio frequency identifier (RFID). The detection unit 15 may detect entrance into the limited area 51 by receiving an entrance signal output from such an entrance detection device as entrance information.

The detection unit 15 also has a function of, when detecting that the user has entered the limited area 51, acquiring information of the entrance time from a watch (not illustrated) built in the mobile terminal 3, and storing the acquired time in the storage device 31 as the entrance time.

The time calculation unit 16 has a function of detecting that a predetermined imparting timing has come after the user enters the limited area 51, and a function of calculating an elapsed time from entrance into the limited area 51 to the imparting timing as a staying time. The imparting timing is a timing at which a lottery request for requesting a lottery as to whether to issue a coupon available in the limited area 51 is output to the server 2. The imparting timing is appropriately set in advance in consideration of the remaining time until the boarding time at which the user who is the soon-to-be passenger 60 boards the plane 58, the coupon lottery request by the user, the shopping time required for purchasing an article using the coupon, and the like. For example, a specific example of the imparting timing is timing when the remaining time until the boarding time reaches a remaining time (for example, 20 minutes) set in advance in consideration of the shopping time. In a case where such timing is set as the imparting timing, the time calculation unit 16 needs to acquire information of the boarding time in order for the time calculation unit 16 to detect the imparting timing. Therefore, for example, the processor 30 has a function of causing the display control unit 17 to display an input screen on which the user manually inputs the information of the boarding time on the display device 33 so that the information of the boarding time can be acquired. In a case where an electronic ticket of the plane 58 is stored in the mobile terminal 3, the processor 30 may have a function of extracting information of a boarding time from the electronic ticket.

Another example of the imparting timing is timing when the user manually inputs a command for requesting lottery of a coupon. In a case where this timing is set as the imparting timing, the processor 30 has a function of causing the display control unit 17 to display an icon or the like for requesting a coupon lottery by manual input by the user on the display device 33.

When the time calculation unit 16 detects that it is the imparting timing after detection unit 15 detects that the user enters limited area 51, for example, time information is acquired from a clock (not illustrated) built in the mobile terminal 3. Then, the time calculation unit 16 calculates the time from the entrance time at which the user enters the limited area 51 to the time of the acquired imparting timing as the staying time in the limited area 51.

The request unit 18 has a function of associating the user identification information with the staying time information indicating the calculated staying time and outputting the staying time information to the server 2 together with the lottery request when the staying time in the limited area 51 is calculated by the time calculation unit 16.

The display control unit 17 has a function of displaying, on the display device 33, the content of a notification for notifying the lottery result (result of winning or losing) of the coupon received from the server 2 and the content of the issued coupon.

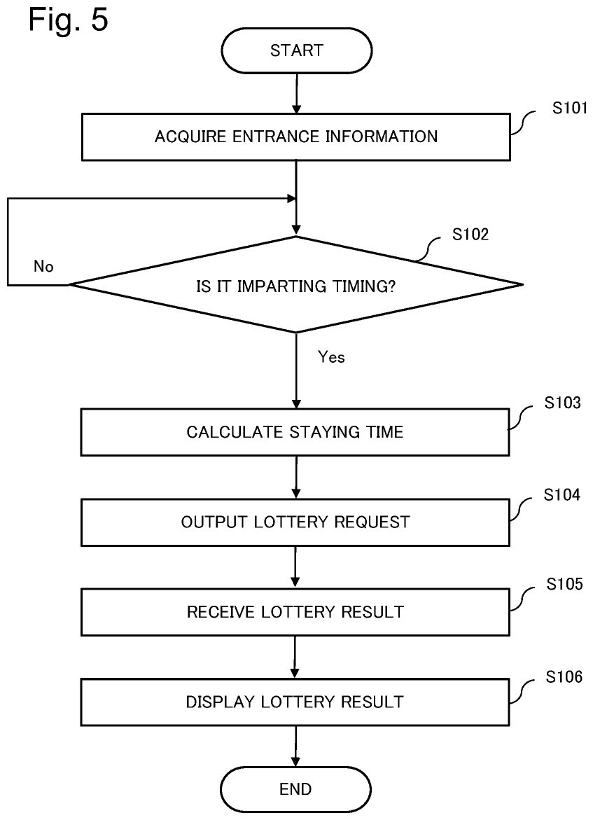

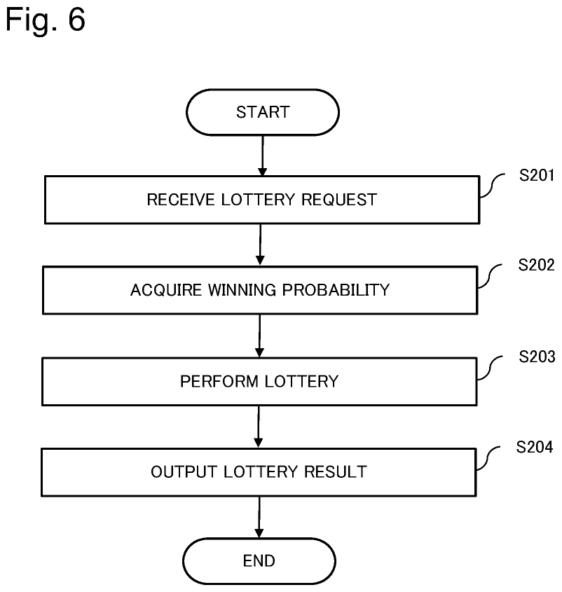

The server 2 and the mobile terminal 3 are configured as described above. Next, an example of the operation of the guiding system 1 in the server 2 and the mobile terminal 3 will be described. FIG. 5 is a flowchart illustrating an example of the operation of the guiding system 1 in the mobile terminal 3. FIG. 6 is a flowchart illustrating an example of the operation of the guiding system 1 in the server 2.

For example, first, when the user who is the soon-to-be passenger 60 enters the limited area 51 from the security check site 54 and the detection unit 15 in the mobile terminal 3 of the user acquires the entrance information (step S101 in FIG. 5), the detection unit 15 acquires the entrance time from the built-in clock of the mobile terminal 3.

Thereafter, the time calculation unit 16 determines whether it is a predetermined imparting timing (step S102). Then, when determining that it is not the imparting timing, the time calculation unit 16 repeats the determination operation of determining whether it is the imparting timing.

Thereafter, when determining that it is the imparting timing, the time calculation unit 16 acquires the current time, and calculates the staying time in the limited area 51 using the acquired time and the entrance time (step S103). When the staying time is calculated, the request unit 18 associates the user identification information with the staying time information including the calculated staying time, and outputs the lottery request to the server 2 together with the staying time information (step S104).

Thereafter, when the information of the lottery result is received from the server 2 (step S105), the display control unit 17 displays the received information of the lottery result on the display device 33 (step S106).

On the other hand, in the server 2, when the reception unit 11 receives the lottery request and the staying time information from the mobile terminal 3 (step 201 in FIG. 6), the imparting unit 12 acquires the staying time from the staying time information and acquires the winning probability of the coupon related to the staying time from the winning probability data (step 202). Then, the imparting unit 12 performs lottery for randomly determining whether to issue a coupon based on the acquired winning probability (step S203). Further, when a plurality of types of coupons are prepared, the imparting unit 12 determines the type of a coupon to be issued. Further, the imparting unit 12 generates (updates) information of the issuance history in which a lottery result, the information indicating the type of the issued coupon when the coupon is issued, and the user identification information are associated with each other, and stores the information in the storage device 22.

After the lottery, the output unit 13 outputs the lottery result to the mobile terminal 3 that has output the lottery request (step S204).

As described above, the guiding system 1 of the first example embodiment issues a coupon to the user with a winning probability according to the staying time in the limited area 51. Therefore, it is assumed that the user (soon-to-be passenger 60) is guided to take an action of moving from the public area 52 to the limited area 51 in order to increase the winning probability of the coupon. That is, the guiding system 1 can give the user an incentive to take an action of moving from the public area 52 to the limited area 51. As a result, the guiding system 1 can guide the user who is the soon-to-be passenger 60 to move to the limited area 51 without staying in the public area 52 for a long time, so that the congestion rate of the public area 52 can be reduced. By reducing the congestion rate of the public area 52, it becomes easy to find a suspicious person in the public area 52, so that the guiding system 1 can exhibit an effect of suppressing terrorism and crime.

Since it is assumed that the staying time during which the user (soon-to-be passenger 60) stays in the limited area 51 becomes longer than a case where the guiding system 1 is not applied, the guiding system 1 can increase opportunities for the user to purchase articles at the store 57. As a result, the guiding system 1 can achieve an effect of promoting the sale of the store 57.

Further, since the guiding system 1 can guide the user (soon-to-be passenger 60) to the limited area 51 with a margin for the time until the boarding time, it is possible to obtain an effect that reduction of the boarding delay of the soon-to-be passenger 60 can be expected.

In the example described above, even when the coupon is lost, the mobile terminal 3 displays the removal on the display device 33. Alternatively, for example, in a case where a process related to entrance to the limited area 51 and a lottery process for determining whether to issue a coupon are executed without the user operating the mobile terminal 3, it is not necessary to display the fact on the display device 33 in a case where the coupon is lost. However, in a case where a command for requesting display of the lottery result of the coupon is input to the mobile terminal 3 by the user operating the mobile terminal 3, the mobile terminal 3 may display not only winning of the coupon but also losing of the coupon by the operation of the display control unit 17 according to the command (request).

In the above-described example, in a case where a plurality of types of coupons are prepared, the imparting unit 12 determines (selects) the type of coupon to be issued when determining the issuance of a coupon. Alternatively, for example, when determining issuance of a coupon, the imparting unit 12 may output information of a plurality of types of coupons as issuance candidates to the mobile terminal 3 that has output the lottery request via the output unit 13. Accordingly, the display control unit 17 of the mobile terminal 3 displays the information on the plurality of types of coupons as the issuance candidates on the display device 33. Then, the type of coupon selected by the user from among the plurality of types of coupons of the issuance candidates displayed on the display device 33 may be determined as the type of coupon to be issued. In this case, the information on the type of the coupon selected by the user is transmitted from the mobile terminal 3 to the server 2, and the imparting unit 12 generates (updates) the information on the issuance history in which the lottery result, the information indicating the type of the issued coupon, and the user identification information are associated with each other on the basis of the transmitted information.

In the above case, in a case where the issuance of the coupon is determined, the coupon selected by the user is issued to the user, so that the guiding system 1 can increase the satisfaction level (customer satisfaction (CS)) of the user. For example, the guiding system 1 can avoid a situation in which it is assumed that the user is displeased that a discount coupon of an article that the user has just purchased is issued.

### Second Example Embodiment

Hereinafter, a second example embodiment according to the present invention will be described. In the description of the second example embodiment, the same reference numerals are given to the same components as the components constituting the guiding system 1 of the first example embodiment, and redundant description of the common parts will be omitted.

In the second example embodiment, not the mobile terminal 3 but the server 2 has the function of detecting that the user has entered the limited area 51 and the function of calculating the staying time of the user in the limited area 51 from the entrance to the imparting timing.

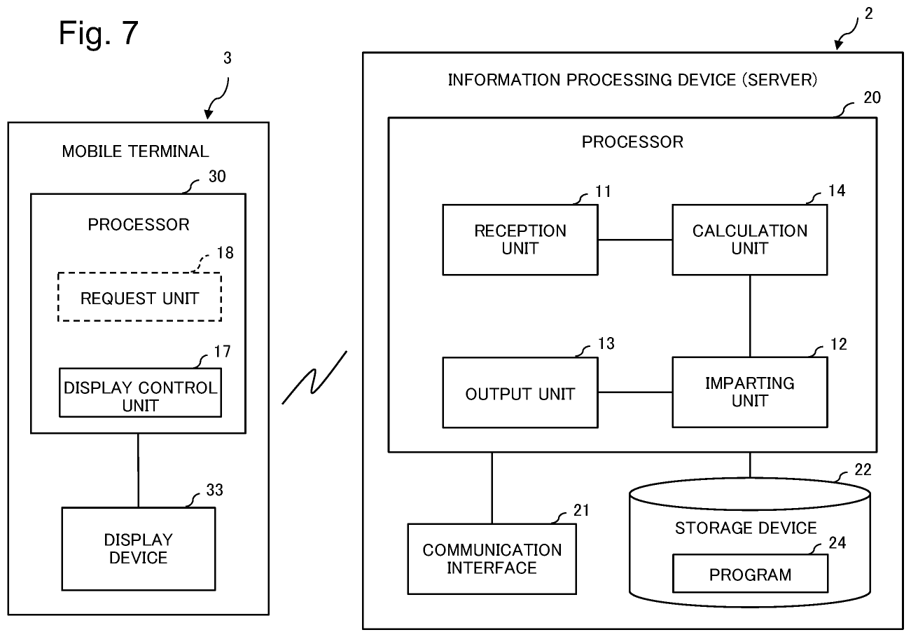

FIG. 7 is a block diagram for explaining a functional configuration of a guiding system 1 of a second example embodiment. The mobile terminal 3 constituting the guiding system 1 of the second example embodiment includes the storage device 31 and the communication interface 32 as in the first example embodiment, but these are not illustrated in FIG. 7.

In the second example embodiment, the processor 20 of the server 2 includes a reception unit 11, an imparting unit 12, an output unit 13, and a calculation unit 14 as functional units.

The reception unit 11 has a function of receiving entrance information. The entrance information is information indicating that the user using the guiding system 1 has entered the limited area 51 of the airport 50. For example, it is assumed that the server 2 is connected to a ticket management system that manages tickets of an airline company, and information on a check-in time at which the user checks in and information on a scheduled boarding time can be acquired from the ticket management system. In such a case, the reception unit 11 receives information of the check-in time and the scheduled boarding time as the entrance information. The entrance information is associated with user identification information for identifying the user who has entered the limited area 51.

Alternatively, the reception unit 11 may receive the entrance information as follows. For example, in the limited area 51, it is assumed that an acquisition device that acquires authentication information for a system is installed near an entrance entering from the security check site 54, and authentication registration information of a user who uses the guiding system 1 is registered in the storage device 22 in advance. Here, the authentication information is predetermined information used in the authentication process of determining whether the authentication target person is a user registered in advance, and is, for example, biometric information of the user such as a password or an image of the user's face. The authentication registration information of the user is registered in the storage device 22 of the server 2 when the user inputs the authentication registration information to the mobile terminal 3 and the input information is transmitted from the mobile terminal 3 to the server 2. The authentication registration information of the user may be registered in a database that is a storage device separate from the server 2.

In the case that the acquisition device is installed, the reception unit 11 receives the authentication information acquired by the acquisition device as the entrance information.

The calculation unit 14 has a function of detecting that the user has entered the limited area 51 or that the user has entered, and a function of calculating the staying time of the user in limited area 51 from the entrance to the imparting timing. For example, in a case where the reception unit 11 receives information of the check-in time and the scheduled boarding time as the entrance information, the calculation unit 14 detects that the user enters the limited area 51 due to the reception of the entrance information. Then, the calculation unit 14 estimates the entrance time at which the user enters the limited area 51 using the check-in time, the scheduled boarding time, and the entrance time calculation data given in advance. The entrance time calculation data is data for calculating the entrance time using the check-in time and the scheduled boarding time, and is obtained, for example, by analyzing a large number of samples including a relationship between the actual check-in time, the scheduled boarding time, and the entrance time. The estimated entrance time information is associated with user identification information.

When the reception unit 11 receives the authentication information as the entrance information, the calculation unit 14 collates the received authentication information with the authentication registration information, and when there is the authentication registration information matching the authentication information, the calculation unit 14 specifies the user related to the authentication information from the authentication registration information. Then, the calculation unit 14 detects that the specified user has entered the limited area 51. Further, the calculation unit 14 acquires the time when the authentication information is received as the entrance time. The information of the entrance time is associated with user identification information obtained from the authentication registration information.

Further, the calculation unit 14 has a function of detecting that the imparting timing has come after the user enters the limited area 51, similarly to the time calculation unit 16 described in the first example embodiment. Here, the imparting timing is a timing at which a lottery is executed as to whether to issue a coupon available in the limited area 51. The imparting timing is appropriately set in advance in consideration of the remaining time to the boarding time when the user boards the plane 58, the user's request, the time required for purchasing an article using the coupon, and the like. Since the calculation unit 14 detects that the imparting timing has come similarly to the time calculation unit 16 described in the first example embodiment, detailed description of detection of the imparting timing is omitted. In a case where a timing when the user manually inputs a command for requesting the coupon lottery is set as the imparting timing, the request unit 18 of the processor 30 in the mobile terminal 3 outputs the lottery request to the server 2 according to the manual input command of the user.

Further, when detecting that the imparting timing has come, the calculation unit 14 acquires time information from, for example, a clock (not illustrated) built in the server 2, similarly to the time calculation unit 16 described in the first example embodiment. Then, the calculation unit 14 calculates, as the staying time, the time from the entrance time at which the user is considered to enter the limited area 51 to the time at which the imparting timing is reached.

When the staying time is calculated by the calculation unit 14, the imparting unit 12 randomly determines whether to issue a coupon with the winning probability according to the staying time as described in the first example embodiment. In a case where a plurality of types of coupons available in the limited area 51 is prepared, the imparting unit 12 determines the type of coupon to be issued, similarly to the first example embodiment.

Similarly to the function of the output unit 13 in the first example embodiment, the output unit 13 also outputs a notification notifying the lottery result of the coupon by the imparting unit 12, the content of the coupon to be issued, and the like to the mobile terminal 3 of the coupon issuing destination.

The display control unit 17 in the mobile terminal 3 displays, on the display device 33, the content of the notification notifying the lottery result of the coupon received from the server 2.

The other functions of the guiding system 1 of the second example embodiment are the same as those of the first example embodiment.

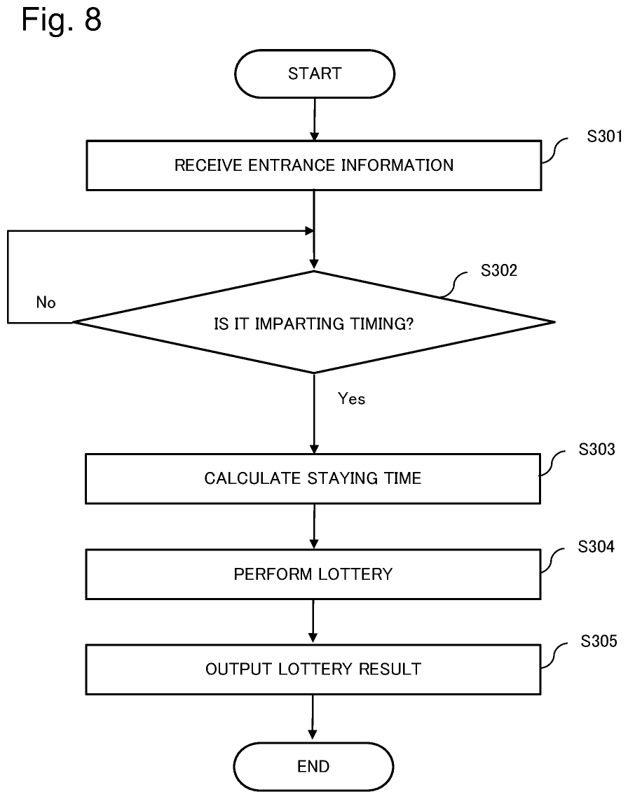

FIG. 8 is a flowchart illustrating an operation example of the server 2 in the guiding system 1 of the second example embodiment. An operation example of the server 2 in the second example embodiment will be described with reference to FIG. 8. For example, when reception unit 11 of server 2 receives the entrance information (step S301 in FIG. 8), calculation unit 14 detects that the user enters limited area 51 or enters, and acquires the entrance time. Then, the calculation unit 14 determines whether it is a predetermined imparting timing (step S302). Then, when determining that it is not the imparting timing, the calculation unit 14 repeats the determination operation of determining whether it is the imparting timing.

Thereafter, when determining that it is the imparting timing, calculation unit 14 acquires the current time, and calculates the staying time in limited area 51 using the acquired time and entrance time (step S303). After the staying time is calculated, the imparting unit 12 performs lottery for randomly determining whether to issue a coupon with a winning probability of the coupon according to the staying time (step S304). Further, when a plurality of types of coupons are prepared, the imparting unit 12 determines the type of a coupon to be issued. Further, the imparting unit 12 generates (updates) information of a coupon issuance history in which a lottery result, information indicating a type of issued coupon in a case of issuing a coupon, and user identification information are associated with each other, and stores the information in the storage device 22.

After the drawing, the output unit 13 outputs the lottery result to the mobile terminal 3 of the user (step S305). As a result, the lottery result is displayed on the display device 33 by the display control operation of the display control unit 17 in the mobile terminal 3 of the user.

As in the first example embodiment, the guiding system 1 of the second example embodiment has a function of issuing a coupon to the user with a winning probability according to the staying time in the limited area 51. As a result, the guiding system 1 of the second example embodiment can also achieve effects similar to those of the first example embodiment, that is, an effect of suppressing terrorism and crime in the public area 52 by reducing congestion in the public area 52, an effect of promoting sales of the store 57 in the limited area 51, and an effect of reducing boarding delay of the soon-to-be passenger 60. Further, in the guiding system 1 according to the second example embodiment, the server 2, instead of the mobile terminal 3, executes processing of detecting that the user has entered the limited area 51 or has entered, and processing of calculating the staying time of the user in the limited area 51. Therefore, the guiding system 1 of the second example embodiment can reduce the load on the mobile terminal 3 according to the guiding system 1 as compared with the first example embodiment.

### Third Example Embodiment

Hereinafter, a third example embodiment according to the present invention will be described. In the description of the third example embodiment, the same reference numerals are given to the same components as the components constituting the guiding system 1 of the first or second example embodiment, and redundant description of the common parts will be omitted.

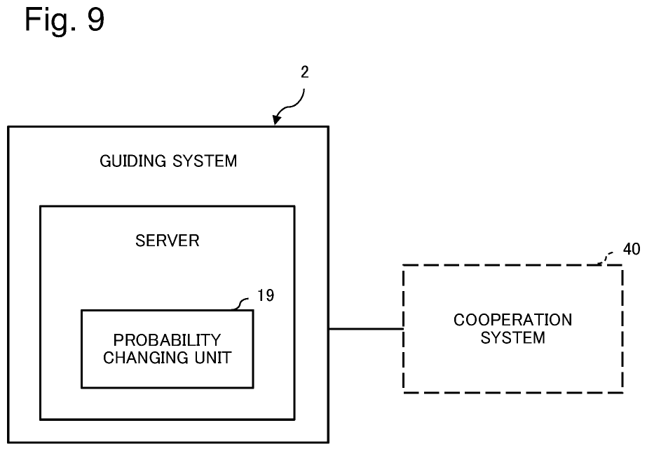

In the guiding system 1 in the third example embodiment, a probability changing unit 19 as illustrated in FIG. 9 is provided in the server 2 in addition to the functions of the guiding system 1 in the first and second example embodiments. The probability changing unit 19 has a function of changing the basic winning probability obtained from the winning probability data stored in the storage device 22 according to a change rule given in advance. The imparting unit 12 performs the coupon lottery using the changed winning probability.

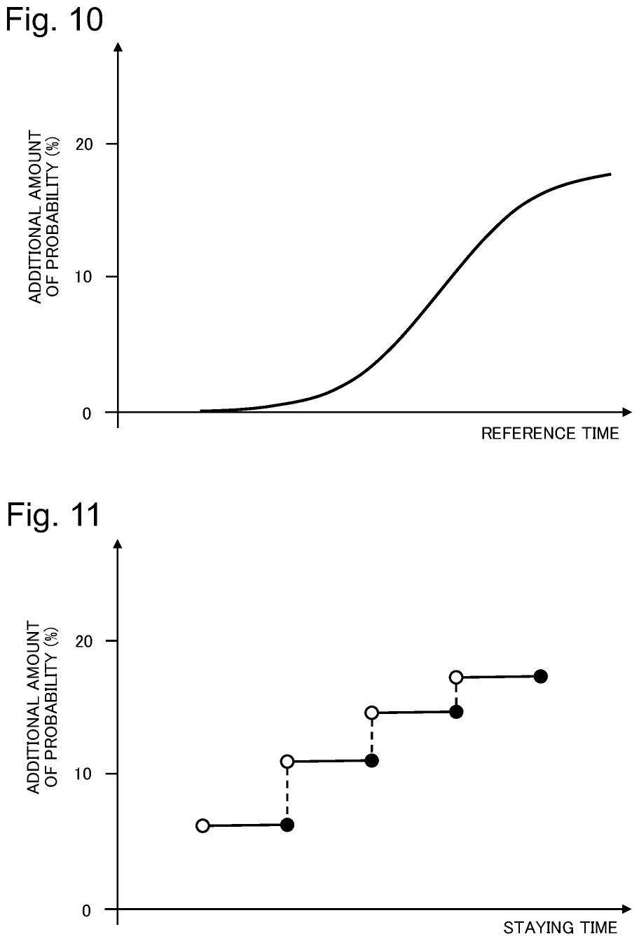

As a rule by which the probability changing unit 19 changes the winning probability, for example, the following change rule can be considered. Here, it is assumed that there is a cooperation system 40 with which the guiding system 1 cooperates, and the cooperation system 40 is a system that manages the status of staying such as hotel checkout. As a change rule in this case, a change rule is conceivable in which the winning probability is increased according to the time from the checkout time of the user at the hotel acquired from the system to the scheduled boarding time. An example of the relationship between the additional amount of the winning probability and the time (also referred to as reference time) from the checkout time to the scheduled boarding time is illustrated in the graph of FIG. 10. The relationship between the additional amount of the winning probability and the time from the checkout time to the scheduled boarding time may be expressed by a mathematical expression.

As another change rule, for example, in a case where the cooperation system 40 is a system of a taxi company, and the user uses a taxi of the taxi company, a change rule of increasing the winning probability by a predetermined fixed probability as an additional amount is considered.

Further, as another change rule, in a case where a cooperation system 40 is the guiding system 1 at another airport and the lottery result of the coupon in the cooperation system 40 is losing, a change rule of increasing the winning probability according to the staying time detected by the cooperation system 40 is considered. An example of the relationship between the additional amount of the winning probability and the staying time is illustrated in the graph of FIG. 11.

Further, as another change rule, for example, in a case where the lottery result of the coupon is lost when the user used the airport 50 last time, a change rule of increasing the winning probability by a predetermined fixed probability as the additional amount is considered.

The probability changing unit 19 determines whether it is necessary to change the winning probability on the basis of the change rule as described above at the timing when the server 2 receives the staying time information from the mobile terminal 3 or the timing when the calculation unit 14 calculates the staying time. Then, in a case where it is determined that the change is necessary, the probability changing unit 19 determines the additional amount of the winning probability according to the change rule. The probability changing unit 19 acquires the winning probability according to the determined staying time from the winning probability data. Further, the probability changing unit 19 calculates the changed winning probability by adding the determined additional amount to the acquired winning probability.

Instead of using the basic winning probability based on the winning probability data, the imparting unit 12 executes the coupon lottery processing using the changed winning probability calculated by the probability changing unit 19.

Instead of changing the winning probability by adding the additional amount of the winning probability based on the change rule to the winning probability acquired from the winning probability data of the storage device 22 based on the staying time, the probability changing unit 19 may change the winning probability as follows. For example, it is assumed that the winning probability data stored in the storage device 22 is set as the basic winning probability data, and a change rule for changing the basic winning probability data is determined in advance and stored in the storage device 22. As an example of the change rule, in a case where the winning probability data is data represented by a sigmoid function as illustrated in FIG. 4, there is a rule of changing the bias term of the sigmoid function on the basis of the information acquired from the cooperation system 40 and shifting the sigmoid function as indicated by a dotted line L in FIG. 4. In a case where the winning probability data is data represented by a linear function, as another example of the change rule, there is a rule of changing the gradient of the linear function or the bias term (intercept) in a direction of increasing the gradient or the bias term on the basis of the information acquired from the cooperation system 40. That is, as an example of the change rule, there is a rule in which, in a case where a hotel, a taxi, or another airport related to the cooperation system 40 is used, the winning probability data is changed in a direction in which the winning probability according to the staying time increases.

In a case where such a change rule is defined, the probability changing unit 19 determines the necessity of change of the winning probability data based on the change rule at the timing when the server 2 receives the staying time information from the mobile terminal 3 or the timing when the calculation unit 14 calculates the staying time. Then, in a case where it is determined that it is necessary to change the winning probability data, the probability changing unit 19 changes the winning probability data according to the change rule, and outputs the changed winning probability data to the imparting unit 12.

In this case, instead of using the basic winning probability data in the storage device 22, the imparting unit 12 acquires the winning probability using the changed winning probability data changed by the probability changing unit 19 and executes the coupon lottery processing.

In a case where the winning probability is changed as described above, the winning probability data and the change rule are set in consideration of each other so that the changed winning probability does not become larger than the upper limit value (for example, 100%) of the winning probability set in advance.

The other functions of the guiding system 1 in the third example embodiment are similar to the functions in the first and second example embodiments.

Since the guiding system 1 of the third example embodiment has a coupon issuing function similar to that of the guiding system 1 of the first or second example embodiment, the same effects as those of the first or second example embodiment can be obtained. In the third example embodiment, a change is made in a direction in which the winning probability of the coupon increases in consideration of the use of facilities or the like that is affiliated with the airport 50 or the number of times of use of the airport 50. Therefore, the guiding system 1 of the third example embodiment can promote the use of the airport 50 and the use of facilities or the like that cooperate with the airport 50 when using the airport 50.

### Fourth Example Embodiment

Hereinafter, a fourth example embodiment according to the present invention will be described. In the description of the fourth example embodiment, the same reference numerals are given to the same components as those constituting the guiding system of the first or second example embodiment, and redundant description of the common parts will be omitted.

The guiding system 1 of the fourth example embodiment has a function of imparting a point according to the staying time instead of issuing a coupon as in the first or second example embodiment. The points mean that a discount according to the number of points can be received when an article (including service) is purchased, or can be exchanged for a cash voucher such as a gift certificate, and can be used in the store 57 that cooperates the guiding system 1.

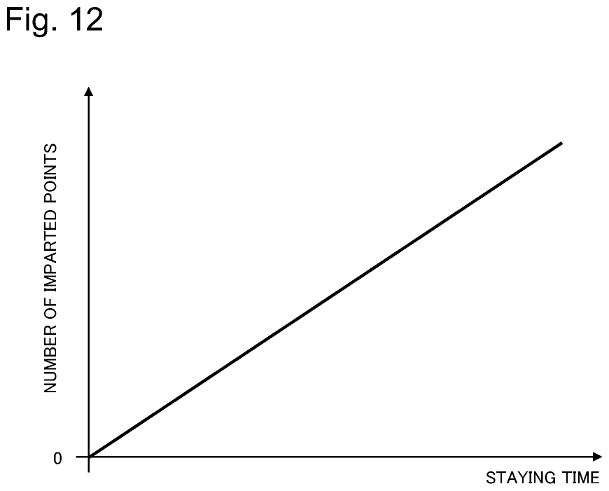

That is, in the fourth example embodiment, relational data between the staying time and the number of points to be imparted (hereinafter, it is also referred to as the number of imparted points) is given in advance as imparted point data to the storage device 22 of the server 2. An example of the imparted point data is illustrated in FIG. 12. The imparted point data may be represented by a mathematical expression for calculating the number of imparted points using the staying time as a parameter.

In the storage device 22 or a database (not illustrated) connected to the server 2, in association with the user identification information, for example, information on the date and time when the user entered the limited area 51 of the airport 50 (information on the entrance time) and information on the number of imparted points due to the entrance, information on the date and time when the points were used and the number of used points, and information on the number of available points after the change changed by the provision or use are stored in time series. Further, relational data between the identification information of the mobile terminal 3 and the user identification information for identifying the user of the mobile terminal 3 is stored in the storage device 22.

Upon receiving the information on the staying time calculated by the time calculation unit 16 in the mobile terminal 3 or the calculation unit 14 in the server 2, the imparting unit 12 uses the imparted point data to acquire the number of imparted points according to the staying time. Then, the imparting unit 12 adds the acquired number of imparted points to the number of available points stored in the storage device 22 or the database in association with the same user identification information as the user identification information associated with the staying time information.

The output unit 13 outputs information on the number of imparted points acquired by entering the limited area 51 and the number of available points to which the number of imparted points has been added, toward the mobile terminal 3 to which the points have been added, using the user identification information. The display control unit 17 of the mobile terminal 3 that has received such information displays the received information on the display device 33.

The function other than the above in the guiding system 1 of the fourth example embodiment is the same as the function of the first or second example embodiment. However, the command output together with the staying time information from the mobile terminal 3 to the server 2 as in the first example embodiment is not a lottery request but a command of an imparting request for requesting the imparting of points.

The guiding system 1 of the fourth example embodiment has a function of imparting the number of points to the user according to the staying time in the limited area 51. Also in the guiding system 1 of the fourth example embodiment, it is possible to achieve the effect of suppressing terrorism and crime in the public area 52, the effect of promoting the sale of the store 57 in the limited area 51, and the effect of reducing the boarding delay of the soon-to-be passenger 60, which are the same effects as the case of issuing a coupon as in the first and second example embodiments.

It is assumed that there is a cooperation system 40 of a hotel, a taxi company, or the like with which the guiding system 1 of the fourth example embodiment cooperates, and information using the hotel or the taxi of the user can be acquired from the cooperation system 40. In this case, the guiding system 1 may set a point obtained by adding a predetermined number of points according to use of a hotel or a taxi to the number of points according to the staying time in the limited area 51 as the number of imparted points.

The guiding system 1 of the fourth example embodiment may cooperate with another system that imparts points so that the points imparted by the guiding system 1 can be used in other than the store 57 in the limited area 51. In such a case, since the use of the imparted point is not limited to the limited area 51, the guiding system 1 may impart the point without considering that the point is imparted, for example, 30 minutes before the boarding time in consideration of using the point in the limited area 51. As a result, the point imparting timing may be, for example, timing at which it is detected that the user gets on the plane 58 from the limited area 51 as the access point in the limited area 51 is no longer connected to the mobile terminal 3 of the user. The point imparting timing may be, for example, timing at which it is detected that the user is not moving to the waiting seat for boarding for a predetermined time (for example, 20 minutes) and is about to board due to the connection state between the access point in the limited area 51 and the mobile terminal 3 of the user.

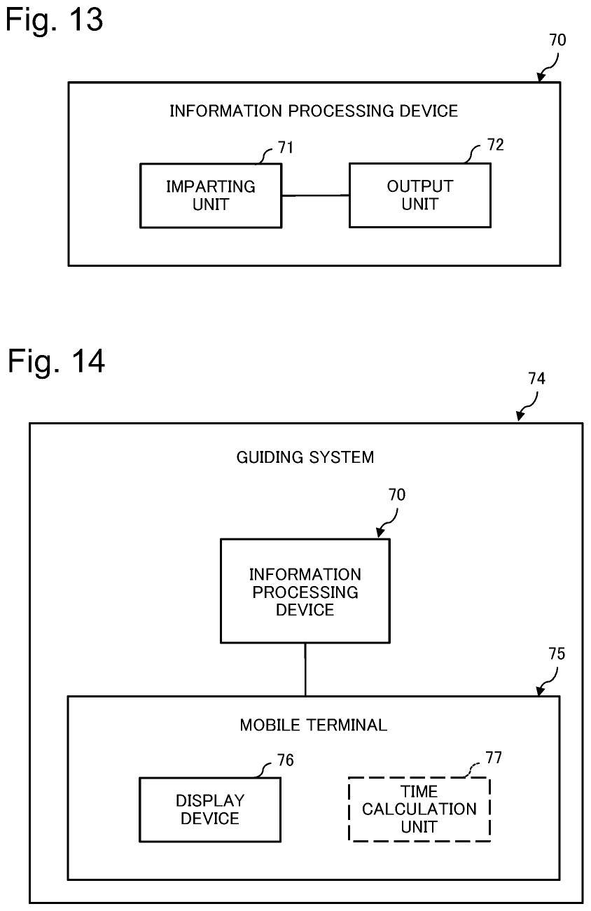

FIG. 13 is a block diagram illustrating a basic configuration of an information processing device constituting the guiding system according to the present invention. An information processing device 70 includes, for example, an imparting unit 71 and an output unit 72 achieved by a processor as basic configurations.

The imparting unit 71 determines whether to issue a coupon or calculates a point on the basis of a staying time in the limited area, the coupon and the point being exchangeable with an article provided in the limited area by a user who is a soon-to-be passenger to board a plane. The limited area indicates an area in which a soon-to-be passenger stays until he or she boards a plane after a security check. The staying time in the limited area indicates an elapsed time from entry to the limited area to a predetermined imparting timing.

The output unit 72 outputs, on a mobile terminal of the user, information notifying of an issuance of a coupon when the imparting unit 71 determines to issue the coupon, or information about the point calculated by the imparting unit 71.

The information processing device 70 having such a basic configuration constructs a guiding system 74 as illustrated in FIG. 14. The guiding system 74 includes a mobile terminal 75 together with the information processing device 70. The mobile terminal 75 is a terminal carried by a user of the guiding system 74, and includes a display device 76. The display device 76 displays the information output by the output unit 72 of the information processing device 70. The mobile terminal 75 may further include a time calculation unit 77 achieved by a processor, for example. The time calculation unit 77 has a function of calculating a staying time from an entrance time acquired by reception of information indicating that the user has entered the limited area to the imparting timing.

As in the first to fourth example embodiments, the guiding system 74 including the information processing device 70 can impart an incentive for guiding from the public area 52 to the limited area 51 to the user who is a soon-to-be passenger. Accordingly, the guiding system 74 can achieve effects similar to those of the first to fourth example embodiments.

The present invention has been described above using the above-described example embodiments as schematic examples. However, the present invention is not limited to the above-described example embodiments. That is, the present invention can apply various aspects that can be understood by those of ordinary skill in the art within the scope of the present invention.

### REFERENCE SIGNS LIST

1, 74 guiding system
2 server
3, 75 mobile terminal
12, 71 imparting unit
13, 72 output unit
14 calculation unit
15 detection unit
16, 77 time calculation unit
19 probability changing unit
33, 76 display device
51 limited area
52 public area
57 store

What is claimed is:

1. An information processing device comprising:
at least one processor configured to:
determine whether to issue a coupon exchangeable for an article provided in a limited area or calculate a number of points exchangeable for an article provided in the limited area, based on a staying time, the staying time being an elapsed time from entrance to the limited area to a predetermined imparting timing, the limited area being an area where a user who is a soon-to-be passenger to board a plane stays until boarding the plane after security check; and
an output means configured to output, to a mobile terminal of the user, information for notifying that the coupon is to be issued when it is determined that the coupon is to be issued or information on the calculated number of points.

2. The information processing device according to claim 1, wherein
the at least one processor randomly determines to issue the coupon with a winning probability according to the staying time when whether to issue the coupon is determined, and imparts the number of points according to the staying time when the number of points is imparted.

3. The information processing device according to claim 2, wherein
the at least one processor is further configured to change the winning probability from a basic winning probability set in advance according to a predetermined change rule.

4. The information processing device according to claim 1, wherein:
the at least one processor is further configured to calculate the staying time from an entrance time acquired by reception of information indicating that the user has entered the limited area to the imparting timing.

5. A guiding system comprising:
the information processing device according to claim 1; and
a mobile terminal including a display device that displays information output by the information processing device.

6. A guiding system comprising:
the information processing device according to claim 1; and
a mobile terminal including a display device that displays information output by the information processing device, and calculates the staying time from an entrance time acquired by reception of information indicating that the user has entered the limited area to the imparting timing.

7. A guiding method comprising:
by a computer,
determining whether to issue a coupon exchangeable for an article provided in a limited area or calculating a number of points exchangeable for an article provided in the limited area, based on a staying time, the staying time being an elapsed time from entrance to the limited area to a predetermined imparting timing, the limited area being an area where a user who is a soon-to-be passenger to board a plane stays until boarding the plane after security check; and
outputting, to a mobile terminal of the user, information for notifying that the coupon is to be issued when it is determined that the coupon is to be issued or information on the calculated number of points.

8. A non-transitory computer readable medium storing a computer program for causing a computer to execute:
determining whether to issue a coupon exchangeable for an article provided in a limited area or calculating a number of points exchangeable for an article provided in the limited area, based on a staying time, the staying time being an elapsed time from entrance to the limited area to a predetermined imparting timing, the limited area being an area where a user who is a soon-to-be passenger to board a plane stays until boarding the plane after security check; and
outputting, to a mobile terminal of the user, information for notifying that the coupon is to be issued when it is determined that the coupon is to be issued or information on the calculated number of points.

9. The guiding method according to claim 7, wherein
the computer randomly determines to issue the coupon with a winning probability according to the staying time when whether to issue the coupon is determined, and imparts the number of points according to the staying time when the number of points is imparted.

10. The guiding method according to claim 9, further comprising:
by the computer,
changing the winning probability from a basic winning probability set in advance according to a predetermined change rule.

11. The guiding method according to claim 7, further comprising:
by the computer,
calculating the staying time from an entrance time acquired by reception of information indicating that the user has entered the limited area to the imparting timing.

12. The non-transitory computer readable medium according to claim 8, wherein
the computer program includes a computer program for causing the computer to execute:
determining randomly to issue the coupon with a winning probability according to the staying time when whether to issue the coupon is determined, and imparting the number of points according to the staying time when the number of points is imparted.

13. The non-transitory computer readable medium according to claim 12, wherein
the non-transitory computer readable medium stores further a computer program for causing the computer to execute:
changing the winning probability from a basic winning probability set in advance according to a predetermined change rule.

14. The non-transitory computer readable medium according to claim 8, wherein
the non-transitory computer readable medium stores further a computer program for causing the computer to execute:
calculating the staying time from an entrance time acquired by reception of information indicating that the user has entered the limited area to the imparting timing.
